(19) United States
(12) Patent Application Publication
(10) Pub. No.: US 2007/0073673 A1
(43) Pub. Date: Mar. 29, 2007

(54) System and method for content management security

(75) Inventors: Ryan Sean McVeigh, Broomfield, CO (US); Steven L. Roth, Westminster, CO (US); Jalpesh Patadia, Boulder, CO (US); Tanya Saarva, Boulder, CO (US); Xiaojiang Zhou, Broomfield, CO (US); Brad Posner, Erie, CO (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/499,468

(22) Filed: Aug. 4, 2006

Related U.S. Application Data
(60) Provisional application No. 60/720,860, filed on Sep. 26, 2005.

(51) Int. Cl. G06F 17/30

(52) U.S. Cl. 707/4

(57) ABSTRACT

In accordance with embodiments, there are provided mechanisms and methods for providing content management security to federated content repositories in a content management system and for interacting with a virtual content repository. These mechanisms and methods can enable embodiments to provide secure access to repositories based upon policies defined at a federated repository level and to secure repository access at the federated level based upon policies defined for differing classes of users. These abilities of embodiments can enable users to create services and applications by integrating content from unsecured repositories.

### CLAIM OF PRIORITY

This application claims the benefit of U.S. Provisional Patent Application No. 60/720,860 entitled IMPROVED CONTENT MANAGEMENT, by Ryan McVeigh et al., filed Sep. 26, 2005 (Attorney Docket No. BEAS-01968US0), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

U.S. patent application Ser. No. XX/XXX,XXX entitled SYSTEM AND METHOD FOR PROVIDING SPI EXTENSIONS FOR CONTENT MANAGEMENT SYSTEM, by Ryan McVeigh et al., filed on May XX, 2006, Attorney Docket No. BEAS-1875US0;

U.S. patent application Ser. No. XX/XXX,XXX entitled SYSTEM AND METHOD FOR CONTENT MANAGEMENT SECURITY, by Ryan McVeigh et al., filed on May XX, 2006, Attorney Docket No. BEAS-1876US0; and

U.S. patent application Ser. No. XX/XXX,XXX entitled SYSTEM AND METHOD FOR INTERACTING WITH VIRTUAL CONTENT REPOSITORY, by Ryan McVeigh et al., filed on May XX, 2006, Attorney Docket No. BEAS-1878US0.

### FIELD OF THE INVENTION

The current invention relates generally to managing content for use with portals and other content delivery mechanisms, and more particularly to a mechanism for providing content management security to federated content repositories.

### BACKGROUND

Content repositories manage and provide access to large data stores such as a newspaper archives, advertisements, inventories, image collections, etc. A content repository can be a key component of a web application such as a portal, which must quickly serve up different types of content in response to user interaction. However, difficulties can arise when trying to integrate more than one vendor's content repository. Each may have its own proprietary application program interface and content services (e.g., conventions for searching and manipulating content, versioning, lifecycles and data formats). Furthermore, each time a repository is added to an application, the application software must be modified to accommodate these differences. What is needed is a coherent system and method for interacting with disparate repositories and for providing a uniform set of content services across all repositories, including those that lack such services.

### BRIEF DESCRIPTION OF THE DRAWINGS

FIG. 1 is an illustration of functional system layers in various embodiments.

FIG. 2 is an illustration of objects/interfaces that can be used to interface repositories comprising content in various embodiments.

FIGS. 3A-3B are operational flow diagrams illustrating a high level overview of a technique for interacting with virtual content repository in an embodiment.

FIG. 4 is an operational flow diagram illustrating a high level overview of a technique for providing content management security to federated content repositories in an embodiment.

FIG. 5 is a hardware block diagram of an example computer system, which may be used to embody one or more components in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with a first aspect and in embodiments, there are provided mechanisms and methods for interacting with a virtual content repository. These mechanisms and methods for interacting with a virtual content repository can enable embodiments to secure repository access at the federated level based upon policies defined for differing classes of users. The ability of embodiments to provide secure repository access at the federated level based upon policies defined for differing classes of users can enable access to portal content, for example, to be readily changed by users making a user request but limit portal content change by users making administrative requests.

In an embodiment and by way of example, a method for interacting with a virtual content repository in a content management system is provided. A method embodiment includes receiving a request to access content stored in at least one of a plurality of content repositories via a common Application Programming Interface (API). Each one of the plurality of content repositories is integrated into a virtual content repository (VCR). The method also includes determining whether the request will be permitted by selecting a security policy to apply to the request based upon a classification of the request. Request may be classified into at least one of an administrative request or a user request. The selected security policy may be applied to the request. Access to content in the VCR is provided when the request satisfies the selected security policy.

In accordance with a second aspect and in embodiments, there are provided mechanisms and methods for providing content management security to federated content repositories in a content management system. These mechanisms and methods for providing content management security to federated content repositories in a content management system can enable embodiments to provide secure access to repositories based upon policies defined at a federated repository level. The ability of embodiments to provide secure access to repositories based upon policies defined at a federated repository level can enable users to create services and applications by integrating content from unsecured repositories.

In an embodiment and by way of example, a method for providing content management security to federated content repositories in a content management system is provided. A method embodiment includes integrating a plurality of content repositories, including a first content repository having a first security mechanism and a second content repository lacking any security mechanism, into a virtual content repository (VCR). A request to access content stored in a first node of a plurality of nodes within the plurality of content repositories and a second node of the plurality of nodes within the plurality of content repositories is intercepted. The request may be intercepted at a common Application Programming Interface (API) providing access to the VCR, for example. The first node includes content stored in the first content repository and the second node includes content stored in the second content repository. A determination is made whether the request will be permitted by applying a security policy to a result set returned by the first content repository and the second content repository responsive to the request and applying the first security mechanism to only that portion of the result set returned by the first content repository. The result set is provided when the request satisfies the security policy and the first security mechanism.

As used herein, the term federated level security is defined as security measures applied to a virtual content repository (VCR), comprised of a plurality of content repositories integrated into the VCR. As used herein, the term Access policy (or “authorization policies”, “security policies” or “policies”) dynamically identify resources (e.g., J2EE resources, an XML document, a section of an XML document, services, information returned by services, etc.) within one or more content repositories for which access is controlled, entities allowed to access each resource, and constraints that apply to each requestor or group of requesters that attempt to access the resource. As used herein, the term result set includes any result provided by one or more services. Result sets may include multiple entries into a single document, file, communication or other data construct.

While the present invention is described with reference to an embodiment in which techniques for providing content management security to federated content repositories are implemented in an application server in conformance with the J2EE Management Framework using executable programs written in the Java™ programming language, the present invention is not limited to the J2EE Management Framework nor the Java™ programming language. Embodiments may be practiced using other interconnectivity specifications or programming languages, i.e., JSP and the like without departing from the scope of the embodiments claimed. (Java™ is a trademark of Sun Microsystems, Inc.).

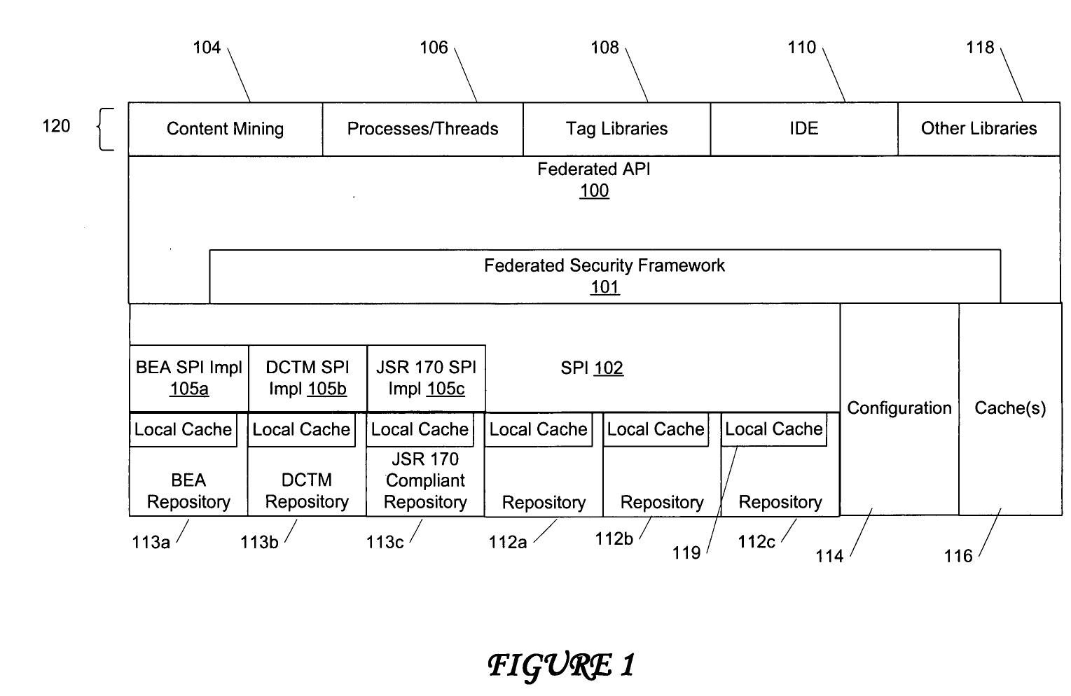

FIG. 1 is an illustration of functional system layers in various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

A content repository 112 represents a searchable data store. Such systems can relate structured content and unstructured content (e.g., digitally scanned paper documents, Extensible Markup Language, Portable Document Format, Hypertext Markup Language, electronic mail, images, video and audio streams, raw binary data, etc.) into a searchable corpus. Content repositories can be coupled to or integrated with content management systems. Content management systems can provide for content workflow management, versioning, content review and approval, automatic content classification, event-driven content processing, process tracking and content delivery to other systems. By way of illustration, if a user fills out a loan application on a web portal, the portal can forward the application to a content repository which, in turn, can contact a bank system, receive notification of loan approval, update the loan application in the repository and notify the user by rendering the approval information in a format appropriate for the web portal.

A virtual or federated content repository (hereinafter referred to as “VCR”) is a logical representation of one or more individual content repositories. For example, the VCR provides a single access point to multiple repositories from the standpoint of application layer 120 but does not shield from the user that there is more than one repository available. Typically, the user interacts with the VCR by specifying which repository an action is related to (such as adding a new node), or performing an action that applies to all repositories (such as searching for content). In various embodiments and by way of illustration, this can be accomplished in part by use of an API (application program interface) 100 and an SPI (service provider interface) 102. An API describes how entities in the application layer can interface with some program logic or functionality. The application layer can include applications (and subdivisions thereof) that utilize the API, such as processes, threads, servlets, portlets, objects, libraries, and other suitable application components. An SPI describes how a service provider (e.g., a content repository, a content management system) can be integrated into a system of some kind. The SPI isolates direct interaction with repositories from the API. In various embodiments, this can be accomplished at run-time wherein the API library dynamically links to or loads the SPI library. In another embodiment, the SPI can be part of a server process such that the API and the SPI can communicate over a network. The SPI can communicate with the repositories using any number of means including, but not limited to, shared memory, remote procedure calls and/or via one or more intermediate server processes.

Embodiments described herein include examples of techniques for interacting with a virtual content repository and techniques for providing content management security to federated content repositories. These techniques involve applying security policies to requests to access content within a virtual content repository comprised of a set of federated content repositories. A policy can be based on role(s) such that it determines which role(s) are permitted to access a resource under certain conditions. (In various embodiments, roles can be defined to dynamically associate users and/or groups of users based on some criteria. For example, a system administrator role might include all users having a certain skill level and only during certain times of day (e.g., after 5:00 pm)). In one embodiment, a policy can be specified as follows (wherein items in square brackets indicate alternatives; italic font indicates optional items):

[GRANT, DENY] (action, resource, subject) IF (constraint condition)1 . . . IF (constraint condition)N;

Where:

GRANT permits a specified action. DENY revokes it;

Action is the name of a resource or resource attribute to grant or deny access to;

Resource is the name of the resource that this policy will be associated with;

Subject is the name of one or more users, groups and/or roles that are granted/denied the action. A special subject called any denotes that any user, group and role is potentially a subject; and

IF (constraint condition) is one or more optional conditions placed on the action. Conditions can include one or more arithmetic and logical functions and expressions involving attributes of resources or other entities in the system, such as requestor attributes, group membership, dynamic attributes (e.g., time, date, location), and other suitable information.

Content repositories may comprise a variety of interfaces for connecting with the repository. For example, as shown in FIG. 1, a BEA format repository 113a provided by BEA Systems, Inc. of San Jose, Calif., a Documentum™ format repository 113b, provided by EMC Corp. of Hopkinton, Mass., and a JSR-170 compliant repository 113c may be integrated into a VCR and made accessible via a single federated API 100 by SPI 102. Individual SPI implementations 105a, 105b, 105c provide format specific service provider interfaces to the BEA format repository 113a, the Documentum™ format repository 113b, and the JSR-170 format repository 113c, respectively. It is noteworthy that not all of the formats illustrated in FIG. 1 will be present in all embodiments. Further, some embodiments will include other repository formats not illustrated by FIG. 1 for brevity.

API's and SPI's can be specified as a collection of classes/interfaces, data structures and/or methods/functions that work together to provide a programmatic means through which VCR service(s) can be accessed and utilized. By way of illustration, APIs and SPIs can be specified in an object-oriented programming language, such as Java™ (available from Sun Microsystems, Inc. of Mountain View, Calif.) and C# (available from Microsoft Corp. of Redmond, Wash.). The API and SPI can be exposed in a number of ways, including but not limited to static libraries, dynamic link libraries, distributed objects, servers, class/interface instances, and other suitable means.

In various embodiments, the API presents a unified view of all repositories to the application layer such that navigation, CRUD operations (create, read, update, delete), versioning, workflows, and searching operations initiated from the application layer operate on the repositories as though they were one. Repositories that implement the SPI can “plug into” the VCR. The SPI includes a set of interfaces and services that support API functionality at the repository level. The API and SPI share a content model that represents the combined content of all repositories as a hierarchical namespace of nodes. Given a node N, nodes that are hierarchically inferior to N are referred to as children of N, whereas nodes that are hierarchically superior to N are referred to as parents of N. The top-most level of the hierarchy is termed the federated root. There is no limit to the depth of the hierarchy. In various embodiments, repositories are children of the federated root. Each repository can itself have children.

By way of illustration, content mining facilities 104, processes/threads 106, tag libraries 108, integrated development environments (IDEs) 110, and other libraries 118 can all utilize the API to interact with a VCR. An IDE can provide the ability for a user to interactively build workflows and/or content views. Content mining facilities can include services for automatically extracting content from the VCR based on parameters. Java ServerPages™ tag libraries enable portals to interact with the VCR and surface its content on web pages. (Java ServerPages™ is available from Sun Microsystems, Inc.) In addition, it will be apparent to those of skill in the art that many other types of applications and software components utilize the API and are, as such, fully within the scope and spirit of the present disclosure.

In various embodiments, the API can include optimizations to improve the performance of interacting with the VCR. One or more caches 116 can be used to buffer search results and/or recently accessed nodes. Some implementations may include additional cache 119 in one or more repositories. In various embodiments, a cache can include a node cache and/or a binary cache. A node cache can be used to provide fast access to recently accessed nodes whereas a binary cache can be used to provide fast access to the binary content/data associated with each node in a node cache. The API can also provide a configuration facility 114 to enable applications, tools and libraries to configure caches and the VCR. In various embodiments, this facility can be can be configured via Java Management Extension (JMX) (available from Sun Microsystems, Inc.).

In various embodiments, a model for representing hierarchy information, content and data types is shared between the API and the SPI. In this model, a node can represent hierarchy information, content or schema information. Hierarchy nodes can serve as containers for other nodes in the namespace akin to a file subdirectory in a hierarchical file system. Schema nodes represent predefined data types. Content nodes represent content/data. Nodes can have a shape defined by their properties. A property associates a name, a data type and an optional a value that is appropriate for the type. In certain of these embodiments, the properties of content nodes contain values. By way of an illustration, a type can be any of the types described in Table 1. Those of skill in the art will appreciate that many more types are possible and fully within the scope and spirit of the present disclosure.

TABLE 1
Exemplary Property Types in Various Embodiments

| PROPERTY TYPE | DESCRIPTION |
|---|---|
| Basic | Text, a number, a date/time, a Boolean value, |
| | a choice, an image, a sound, a bit mask, an |
| | audio/visual presentation, binary data. |
| Link | A pointer/reference to data that lives |
| | “outside” of a node. |
| Lookup | An expression to be evaluated for locating |
| | another node in the VCR |
| Database Mapped | Maps to an existing database table or view. |
| (or schema) | |
| Nested | One or more schemas define individual properties. |

In various embodiments, a property can also indicate whether it is required, whether it is read-only, whether it provides a default value, and whether it specifies a property choice. A property choice indicates if a property is a single unrestricted value, a single restricted value, a multiple unrestricted value, or a multiple restricted value. Properties that are single have only one value whereas properties that are multiple can have more than one value. If a property is restricted, its value(s) are chosen from a finite set of values. But if a property is unrestricted, any value(s) can be provided for it. A property can also be designated as a primary property. By way of illustration, the primary property of a node can be considered its default content. For example, if a node contained a binary property to hold an image, it could also contain a second binary property to represent a thumbnail view of the image. If the thumbnail view was the primary property, software applications such as browser could display it by default.

A named collection of one or more property types is a schema. A schema node is a place holder for a schema. In various embodiments, schemas can be used to specify a node's properties. By way of illustration, a Person schema with three properties (Name, Address and DateofBirth) can be described for purposes of discussion as follows:

Schema Person = {

<Name=Name, Type=Text>,
<Name=Address, Type=Address>,
<Name=DateofBirth, Type=Date>}

Various embodiments allow a node to be defined based on a schema. By way of illustration, a content node John can be given the same properties as the schema Person:
Content Node John is a Person

In this case, the node John would have the following properties: Name, Address and DateofBirth. Alternatively, a node can use one or more schemas to define individual properties. This is sometimes referred to as nested types. In the following illustration, John is defined having an Info property that itself contains the properties Name, Address and DateofBirth. In addition, John also has a CustomerId property:

Content Node John = {

<Name=Info, Type=Person>,
<Name=CustomerId, Type=Number> }

Schemas can be defined logically in the VCR and/or in the individual repositories that form the VCR. In certain embodiments, schemas can inherit properties from at least one other schema. Schema inheritance can be unlimited in depth. That is, schema A can inherit from schema B, which itself can inherit from schema C, and so on. If several schemas contain repetitive properties, a “base” schema can be configured from which the other schemas can inherit. For example, a Person schema containing the properties Name, Address and DateofBirth, can be inherited by an Employee schema which adds its own properties (i.e., Employee ID, Date of Hire and Salary):

Schema Employee inherits from Person = {

<Name=EmployeeID, Type= Number>,
<Name=DateofHire, Type=Date>,
<Name=Salary, Type= Number> }

Thus, as defined above the Employee schema has the following properties: Name, Address, DateofBirth, EmployeeID, DateofHire and Salary. If the Person schema had itself inherited properties from another schema, those properties would also belong to Employee.

In various embodiments, nodes have names/identifiers and can be specified programmatically or addressed using a path that designates the node's location in a VCR namespace. By way of illustration, the path can specify a path from the federated root (‘/’) to the node in question (‘c’):
/a/b/c

In this example, the opening ‘/’ represents the federated root, ‘a’ represents a repository beneath the federated root, ‘b’ is a hierarchy node within the ‘a’ repository, and ‘c’ is the node in question. The path can also identify a property (“property1”) on a node:
/a/b/c.property1

In aspects of these embodiments, the path components occurring prior to the node name can be omitted if the system can deduce the location of the node based on context information.

In various embodiments, a schema defined in one repository or the VCR can inherit from one or more schemas defined in the same repository, a different repository or the VCR. In certain aspects of these embodiments, if one or more of the repositories implicated by an inherited schema do not support inheritance, the inheriting schema can be automatically defined in the VCR by the API. In one embodiment, the inheriting schema is defined in the VCR by default.

By way of illustration, the Employee schema located in the Avitech repository inherits from the Person schema located beneath the Schemas hierarchy node in the BEA repository:

Schema /Avitech/Employee inherits from /BEA/Schemas/Person = {

<Name=EmployeeID, Type= Number>,
<Name=DateofHire, Type=Date>,
<Name=Salary, Type= Number> }

In various embodiments, the link property type (see Table 1) allows for content reuse and the inclusion of content that may not be under control of the VCR. By way of illustration, the value associated with a link property can refer/point to any of the following: a content node in a VCR, an individual property on a content node in a VCR, a file on a file system, an object identified by a URL (Uniform Resource Locator), or any other suitable identifier. In various embodiments, when editing a content node that has a link property type, a user can specify the link destination (e.g., using a browser-type user interface). In certain aspects of these embodiments, if a link refers to a content node or a content node property that has been moved, the link can be resolved automatically by the system to reflect the new location.

In various embodiments, a value whose type is lookup (see Table 1) can hold an expression that can be evaluated to search the VCR for instances of content node(s) that satisfy the expression. Nodes that satisfy the expression (if any) can be made available for subsequent processing. In various embodiments, a lookup expression can contain one or more expressions that can substitute expression variables from: the content node containing the lookup property, a user profile, anything in the scope of a request or a session. In various embodiments, an expression can include mathematical, logical and Boolean operators, function/method invocations, macros, SQL (Structured Query Language), and any other suitable query language. In various embodiments, an expression can be pre-processed one or more times to perform variable substitution, constant folding and/or macro expansion. It will be apparent to those of skill in the art that many other types of expressions are possible and fully within the scope and spirit of this disclosure.

In various embodiments, when editing a content node that has a lookup property type, the user can edit the expression through a user interface that allows the user to build the expression by either entering it directly and/or by selecting its constituent parts. In addition, the user interface can enable the user to preview the results of the expression evaluation.

Database mapped property types (see Table 1) allow information to be culled (i.e., mapped) from one or more database tables (or other database objects) and manipulated through node properties. By way of illustration, a company might have “content” such as news articles stored as rows in one or more RDBMS (Relational Database Management System) tables. The company might wish to make use of this “content” via their portal implementation. Further, they might wish to manage the information in this table as if it existed in the VCR. Once instantiated, a content node property that is of the database mapped type behaves as though its content is in the VCR (rather than the database table). In one embodiment, all API operations on the property behave the same but ultimately operate on the information in the database table.

In various embodiments, a given database mapped property type can have an expression (e.g., SQL) which, when evaluated, resolves to a row and a column in a database table (or resolves to any kind of database object) accessible by the system over one or more networks. A database mapped property will be able to use either native database tables/objects or database views on those tables/objects. It will be appreciated by those of skill in the art that the present disclosure is not limited to any particular type of database or resolving expression.

In aspects of certain embodiments, a schema can be automatically created that maps to any row in a database table. The system can inspect the data structure of the table and pre-populate the schema with database mapped properties corresponding to columns from the table. The table column names can be used as the default property names and likewise the data type of each column will determine the data type of each corresponding property. The system can also indicate in the schema which properties correspond to primary key columns. If certain columns from the table are not to be used in the new schema, they can be un-mapped (i.e. deselected) by a user or a process. A content node can be based on such a schema and can be automatically bound to a row in a database table (or other database object) when it is instantiated. In various embodiments, a user can interactively specify the database object by browsing the database table.

While not required by all embodiments, some embodiments employ a display template (or “template”) to display content based on a schema. Templates can implement various “views”. By way of illustration, views could be “full”, “thumbnail”, and “list” but additional “views” could be defined by end-users. A full view can be the largest, or full page view of the content. A thumbnail view would be a very small view and a list view can be used when displaying multiple content nodes as a “list” on the page (e.g., a product catalog search results page). In various embodiments, the association between a schema and templates can be one-to-many. A template can be designated as the default template for a schema. In certain of these embodiments, templates can be designed with the aid of an integrated development environment (IDE). It is noteworthy that template technology is not limited to web applications. Other delivery mechanisms such as without limitation mobile phones, XML, and the like can be enabled by this technology.

In various embodiments and by way of illustration, display templates can be implemented using HTML (Hypertext Markup Language) and JSP (Java® Server Pages). By way of a further illustration, such a display template can be accessed from a web page through a JSP tag that can accept as an argument the identifier of a content node. Given the content node, the node's schema and associated default display template can be derived and rendered. Alternatively, the JSP tag can take an additional argument to specify a view other than the default. In another embodiment, display templates can be automatically generated (e.g., beforehand or dynamically at run-time) based on a content node's schema. In other embodiments, the view (e.g., full, thumbnail, list) can be determined automatically based on the contents of an HTTP request.

In various embodiments, a role is a dynamic set of users. By way of illustration, a role can be based on functional responsibilities shared by its members. In aspects of these embodiments, a role can be defined by one or more membership criteria. Role mapping is the process by which it is determined whether or not a user satisfies the membership criteria for a given role. For purposes of discussion, a role can be described as follows:
Role=PMembers+[Membership Criteria]

where PMembers is a set of user(s), group(s) and/or other role(s) that form a pool of potential members of this role subject to the Membership Criteria, if any. A user or a process can be in a role, if that user or process belongs to PMembers or satisfies the Membership Criteria. It is noteworthy that a user or process does not need to be a member of PMembers to be considered a member of the role. For example, it is possible to define a role with a criterion such as: “Only on Thursdays” as its membership criteria. All users would qualify as a member of this role on Thursdays. The Membership Criteria can include one or more conditions. By way of illustration, such conditions can include, but are not limited to, one or more (possibly nested and intermixed) Boolean, mathematical, functional, relational, and/or logical expressions. By way of illustration, consider the following Administrator role:
Administrator=Joe, Mary, SuperUser+CurrentTime>5:00 pm

The role has as its potential members two users (Joe and Mary) and users belonging to the user group named SuperUser. The membership criteria includes a condition that requires the current time to be after 5:00 pm. Thus, if a user is Joe, Marry or belongs to the SuperUser group, and the current time is after 5:00 pm, the user is a member of the Administrator role.

In various embodiments, roles can be associated with Resource(s). By way of illustration, a resource can be any system and/or application asset (e.g., VCR nodes and node properties, VCR schemas and schema properties, operating system resources, virtual machine resources, J2EE application resources, and any other entity that can be used by or be a part of software/firmware of some kind). Typically, resources can be arranged in one or more hierarchies such that parent/child relationships are established (e.g., the VCR hierarchical namespace and the schema inheritance hierarchy). In certain of these embodiments, a containment model for roles is followed that enables child resources to inherit roles associated with their parents. In addition, child resources can override their parents' roles with roles of their own.

In various embodiments, Membership Criteria can be based at least partially on a node's properties. This allows for roles that can compare information about a user/process to content in the VCR, for example. In various embodiments, a node's property can be programmatically accessed using dot notation: Article. Creator is the Creator property of the Article node. By way of illustration, assume an Article node that represents a news article and includes two properties: Creator and State. A system can automatically set the Creator property to the name of the user that created the article. The State property indicates the current status of the article from a publication workflow standpoint (e.g., whether the article is a draft or has been approved for publication). In this example, two roles are defined (see Table 2).

TABLE 2
Exemplary Roles in an Embodiment

| ROLE | ASSOCIATED | | MEMBERSHIP |
|---|---|---|---|
| NAME | WITH | PMEMBERS | CRITERIA |
| Submitter | Article | Article.Creator | Article.State = Draft |
| Approver | Article | Editor | Article.State = |
| | | | (Submitted or Approved) |

The Submitter and Approver roles are associated with the Article node. Content nodes instantiated from this schema will inherit these roles. If a user attempting to access the article is the article's creator and the article's state is Draft, the user can be in the Submitter role. Likewise, if a user belongs to an Editor group and the article's state is Submitted or Approved, then the user can belong to the Approver role.

In various embodiments, a policy can be used to determine what capabilities or privileges for a given resource are made available to the policy's Subjects (e.g., user(s), group(s) and/or role(s)). For purposes of discussion, a policy can be described as follows:

Policy = Resource + Privileges(s) + Subjects

+ [Policy Criteria]

Policy mapping is the process by which Policy Criteria, if any, are evaluated to determine which Subjects are granted access to one or more Privileges on a Resource. Policy Criteria can include one or more conditions. By way of illustration, such conditions can include, but are not limited to, one or more (possibly nested and intermixed) Boolean, mathematical, functional, relational, and/or logical expressions. Aspects of certain embodiments allow policy mapping to occur just prior to when an access decision is rendered for a resource.

Similar to roles, in certain of these embodiments a containment model for policies is followed that enables child resources to inherit policies associated with their parents. In addition, child resources can override their parents' polices with policies of their own.

In various embodiments, policies on nodes can control access to privileges associated with the nodes. By way of illustration, given the following policies:

Policy1 = Printer504 + Read/View + Marketing
Policy2 = Printer504 + All + Engineering

the Marketing role can read/view and browse the Printer504 resource whereas the Engineering role has full access to it (“All”). These privileges are summarized in Table 3. Policy1 allows a user in the Marketing role to merely view the properties of Printer504 whereas Policy2 allows a user in the Engineering role to view and modify its properties, to create content nodes based on Printer504 (assuming it is a schema), and to delete the resource.

TABLE 3
Exemplary Privileges for a “Printer504” Node
in Various Embodiments

| ROLE | CREATE | READ/VIEW | UPDATE | DELETE |
|---|---|---|---|---|
| Marketing | | X | | |
| Engineering | x | X | x | X |

Aspects of certain of these embodiments include an implied hierarchy for privileges wherein child privilege(s) of a parent privilege are automatically granted if the parent privilege is granted by a policy.

In various embodiments, the containment models for polices and roles are extended to allow the properties of a node to inherit the policies and roles that are incident on the node. Roles/polices on properties can also override inherited roles/polices. For purposes of illustration, assume the following policy on a Power property of Printer504:
Policy3=Printer504.Power+Update+Marketing

In Policy3, the Marketing role is granted the right to update the Power property for the printer resource Printer504 (e.g., control whether the printer is turned on or off). By default, the Read/View property is also granted according to an implied privilege hierarchy. (There is no Browse privilege for this property.) See Table 4. Alternatively, if there was no implied privilege hierarchy, the Power property would inherit the read/view privilege for the Marketing role from its parent, Printer504. Although no policy was specified for the Power property and the Engineering role, the privileges accorded to the Engineering role can be inherited from a parent node. These privileges are summarized in Table 4.

TABLE 4
Exemplary Privileges for the “Power” Property
in the “Printer504” Node

| ROLE | CREATE | READ/VIEW | UPDATE | DELETE |
|---|---|---|---|---|
| Marketing | | X | x | |
| Engineering | X | X | x | x |

In various embodiments, the ability to instantiate a node based on a schema can be privileged. This can be used to control which types of content can be created by a user or a process. By way of illustration, assume the following policy:
Policy4=Press_Release+Instantiate+Marketing, Manager

Policy4 specifies that nodes created based on the schema Press_Release can only be instantiated by users/processes who are members of the Marketing and/or Manager roles. In aspects of certain of these embodiments, user interfaces can use knowledge of these policies to restrict available user choices (e.g., users should only be able to see and choose schemas on which they have the Instantiate privilege).

In various embodiments, policies can be placed on schemas. For purposes of illustration, assume the following policies:

Policy5 = Press_Release + Read/View + Everyone
Policy6 = Press_Release + All + Public_Relations

TABLE 5
Exemplary Privileges for the “Press Release” Schema

| | CREATE | | | |
|---|---|---|---|---|
| ROLE | INSTANCE | READ/VIEW | UPDATE | DELETE |
| Everyone | | X | | |
| Public Relations | X | X | x | x |

A CAN_ASSOCIATE capability can be set on the workflow, node or type. For example only if the user has the CAN_ASSOCIATE capability on workflow XYZ, the user can associate it with a node or a type. Furthermore, to associate it with a node, the user should have a CAN_ASSOCIATE on the node too. The same is true for the type.

With reference to Table 5 and by way of illustration, assume a content node instance was created based on the Press Release schema. By default, it would have the same roles/polices as the Press Release schema. If a policy was added to the node giving a role “Editor” the privilege to update the node, the result would be additive. That is, Everyone and Public Relations would maintain their original privileges.

In various embodiments, policies can be placed on properties within a schema, including property choices. (Property choices are a predetermined set of allowable values for a given property. For example, a “colors” property could have the property choices “red”, “green” and “blue”.)

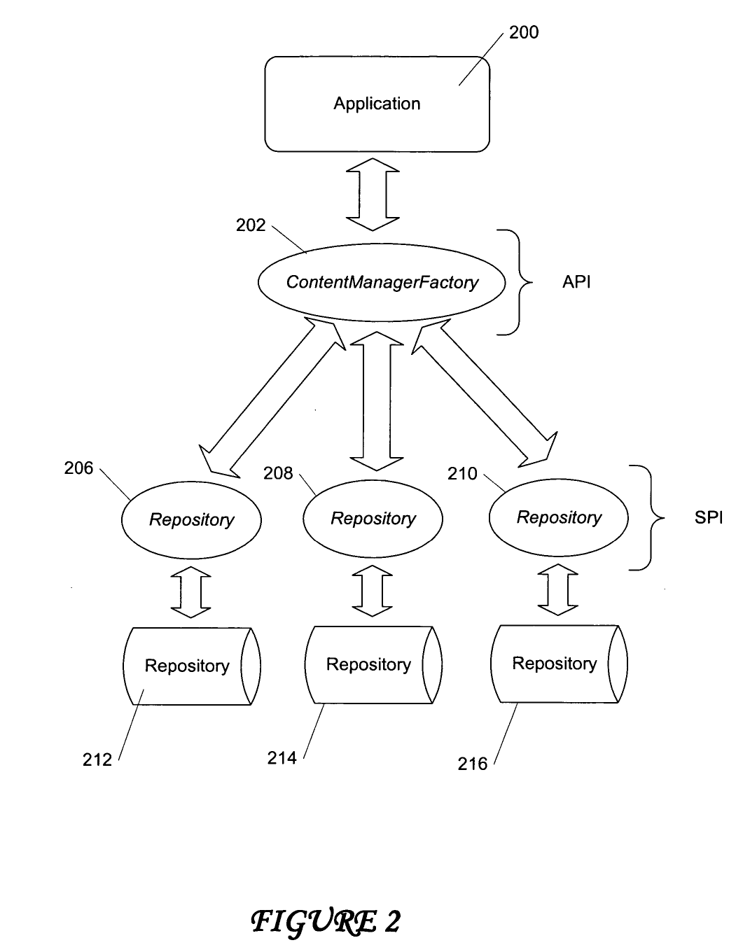

FIG. 2 is an illustration of objects/interfaces that can be used to interface repositories comprising content in various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

The ContentManagerFactory 202 can serve as a representation of an access device from an application program's 200 point of view. In aspects of these embodiments, the ContentManagerFactory attempts to connect all available repositories to the device (e.g., 212-216); optionally with user or process credentials. In various embodiments, this can be based on the Java™ Authentication and Authorization Service (available from Sun Microsystems, Inc.). Those of skill in the art will recognize that many authorization schemes are possible without departing from the scope and spirit of the present disclosure. An SPI Repository object 206-210 represents each available content repository. In an embodiment, the ContentManagerFactory can invoke a connect( ) method on the set of Repository objects. It is noteworthy that, in some embodiments, the notion of “connecting” to a repository is not exposed to users. In various embodiments, the ContentManagerFactory returns a list of repository session objects to the application program, one for each repository for which a connection was attempted. Any error in the connection procedure can be described by the session object's state. In another embodiment, the ContentManagerFactory can connect to a specific repository given the repository name. In various embodiments, the name of a repository can be a URI (uniform resource identifier).

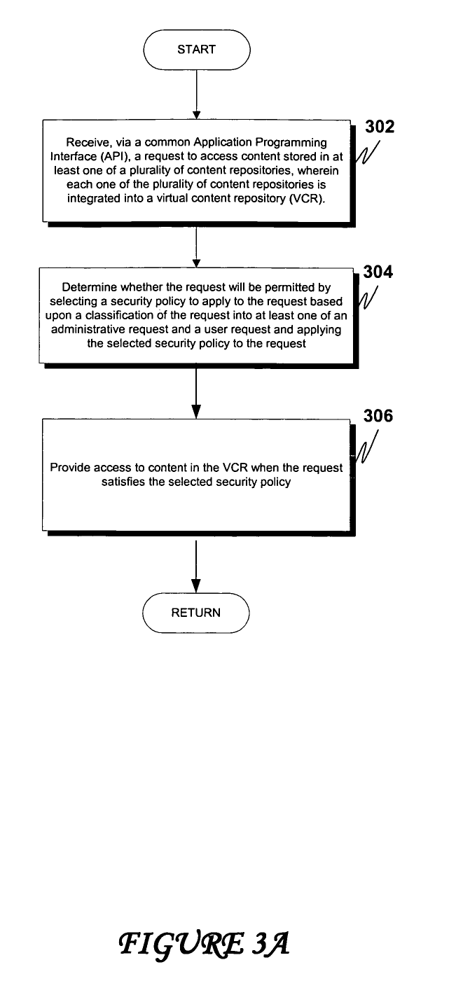

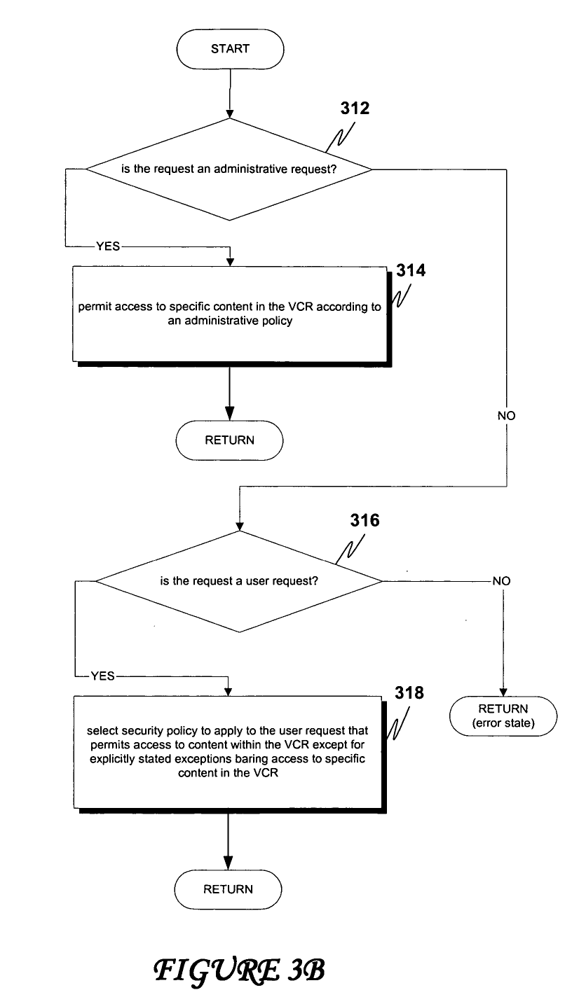

FIG. 3A is an operational flow diagram illustrating a high level overview of a technique for interacting with a virtual content repository in an embodiment. The technique for interacting with a virtual content repository shown in FIG. 3A is operable with an application, such as application 200 of FIG. 2 for example. As shown in FIG. 3A, a request to access content stored in at least one of a plurality of content repositories is received via a common Application Programming Interface (API) (block 302). For example and without limitation, this can include receiving the request to access content stored in at least one of a plurality of content repositories from at least one of an administrator and a user. Each one of the plurality of content repositories is integrated into a virtual content repository (VCR). It is determined whether the request will be permitted by selecting a security policy to apply to the request based upon a classification of the request. Requests may be classified into at least one of an administrative request and a user request, for example. The selected security policy may be applied to the request (block 304). By way of example and without limitation, this can include processing such as that illustrated by FIG. 3B below. Access to content in the VCR is provided when the request satisfies the selected security policy (block 306). In embodiments, this can include enabling at least one of navigation, CRUD operations (create, read, update, delete), versioning, workflows, and searching operations to operate on a plurality of repositories as though the plurality of repositories were one repository.

Some embodiments may also include redacting content received from the VCR prior to providing the content responsive to the request when the request does not satisfy the selected security policy. Alternatively, other embodiments may redact the request prior to accessing content in the VCR when the request does not satisfy the selected security policy. In another alternative approach, embodiments may block the request altogether when the request does not satisfy the selected security policy.

FIG. 3B is an operational flow diagram illustrating a high level overview of a technique for determining whether the request will be permitted by selecting a security policy to apply to the request based upon a classification of the request in an embodiment. As shown by FIG. 3B, a determination is made based upon the classification of the request whether the request is an administrative request (block 312). If so, then permit access to specific content in the VCR according to an administrative policy (block 314). In an embodiment, the security policy to apply to the administrative request is based upon a default administrative security policy that bars access to content within the VCR except for explicitly stated exceptions permitting access to specific content in the VCR

Otherwise, a determination is made based upon the classification of the request whether the request is a user request (block 316). If so, then a security policy is selected to apply to the user request (block 318). The security policy to apply to the user request is based upon a default user security policy that permits access to content within the VCR except for explicitly stated exceptions baring access to specific content in the VCR.

In some embodiments, security measures may be implemented at the repository level in addition to security at the federated level.

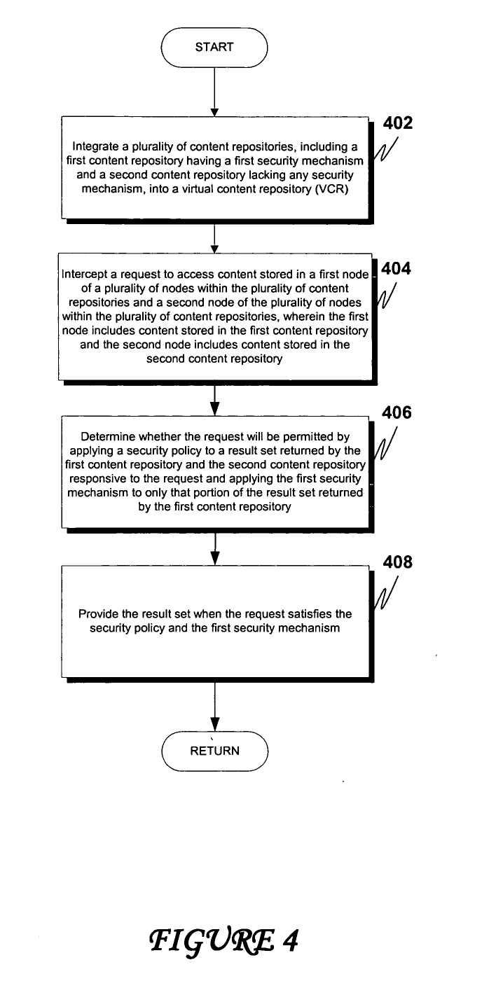

FIG. 4 is an operational flow diagram illustrating a high level overview of a technique for providing content management security to federated content repositories in an embodiment. The technique for providing content management security to federated content repositories shown in FIG. 4 is operable with an application, such as application 200 of FIG. 2 for example. As shown in FIG. 4, a plurality of content repositories, including a first content repository having a first security mechanism and a second content repository lacking any security mechanism, is integrated into a virtual content repository (VCR) (block 402). A request to access content stored in a first node of a plurality of nodes within the plurality of content repositories and a second node of the plurality of nodes within the plurality of content repositories is intercepted (block 404). The request may be intercepted at a common Application Programming Interface (API) providing access to the VCR, for example. The first node includes content stored in the first content repository and the second node includes content stored in the second content repository. A determination is made whether the request will be permitted by applying a security policy to a result set returned by the first content repository and the second content repository responsive to the request and applying the first security mechanism to only that portion of the result set returned by the first content repository (block 406). The result set is provided when the request satisfies the security policy and the first security mechanism (block 408).

In an embodiment, the method includes redacting content from the result set to make the result set permissible according to the selected security policy. In an embodiment, the method includes redacting content from only that portion of the result set returned by the second content repository to make the result set permissible according to the first security mechanism. In an embodiment, the method includes blocking the request altogether when the request does not satisfy the selected security policy. Next, capabilities of content management security will be described with reference to an example embodiment.

NodeManager Capabilities

The Following capabilities are provided by the NodeManager API:
View: The View Capability on a node determines whether the given node and the node's properties can be read by the given user. A user might not be able to read the node but obtain a list of children for the node.
Update: The Update Capability determines whether the given node properties can be updated by the user or not.
Create: The Create Capability determines whether the current user can create child nodes below the given node.
Delete: The Delete capability grants the user the right to delete that node and all it's children.
Can Associate: This capability determines whether or not a user can associate a workflow to a node for workflow operations.
Can Publish: This capability determines whether or not a user can publish content associated with a node.
   TypeManager Capabilities

The Following capabilities are provided by the TypeManager API:
View: The View Capability on a type determines whether the given type can be viewed by the user.
Update: The Update Capability determines whether the given type and it's property definitions can be updated by the user or not. Having an update capability does not guarantee the update operation on a type—it might not be allowed if there are instances of the type in the system for example.
Delete: The Delete capability grants the user the right to delete that type and all it's subtypes. Please note that even though a user has delete privileges they might not still be able to delete a type if there are instances of the type, or of any of it's subtypes.
Create: Create capability on a type allows users to create subtypes below that given type.
Can Associate: This capability determines whether or not a user can associate a workflow to a type for workflow operations.
Can Instantiate: This capability determines whether or not a user can instantiate this type. Again, having this capability does not guarantee instantiation of the type. It might not be possible if the type is declared as abstract, for example.
   WorkflowManager Capabilities

The Following capabilities are provided by the WorkflowManager API:
View: The View Capability determines whether the workflow (meta-data and document) can be viewed by the user.
Update: The Update Capability determines whether the workflow (meta-data and document) can be updated by the user. Having an Update capability does not guarantee update of the workflow. The operation will be disallowed if there are nodes that are associated with the workflow.
Delete: The Delete capability grants the user the right to delete that workflow. The Delete operation will be disallowed if there are nodes associated with the workflow.
Create: Create capability allows users to create workflow documents for the repository. Typically the create capability will be placed on the repository and not on individual workflow documents.
Can Associate: The Can Associate capability allows user to pick the workflow to associate with the node. Note that a user would still need Can Associate capability on the node to associate the workflow with the node.
   VirtualRepositaryManager Capabilities

The Following capabilities are provided by the VirtualRepositoryManager API:
Can Manage: This capability determines whether or not a user can Edit/Update/Delete/View a given capability.
   Communities Support

Delegated administration is available for users who log into the admin tools. Visitor Entitlements is for all visitors to WLP. With DA, you can create hierarchies of delegates to further delegate capabilities to other delegated administrators. For visitor entitlements, the notion of a hierarchy does not exist, and they cannot delegate to other users. Since Community roles are based on Delegated Administration (DA), embodiments will provide a way to secure content access. For example, in an embodiment, the Rules Engine may be modified to provide support for creating Roles based on Content Nodes (i.e., by providing a NodeWrapper service so that the rules engine can understand content resources). An alternative embodiment is outlined below:
1. Create a role called “CommunityContentRole” that will be in a separate namespace than the DA roles or entitlement roles. In an embodiment, this role will be based on a dynamic LHS/RHS rule. The role can be based upon an expression of the type. For example: request.getPrincipal( )==request.getAttribute(“nodeOwner”) && request.getNodeVisitor=“Private” ∥ “Public”
2. Role editors will have to manually suppress editing or recognize dynamically the shape of an role it cannot edit, and display a corresponding message.
3. When a new community repository is created this role will also be created and a security policy will be created and attached to that repository. A single instance of this role can protect all instances of community in a single repository. The OOTB community repository needs to get bootstrapped with this security policy. The role, at a DA scope needs to get bootstrapped into the DA role pool.
4. A new flag, called IS_COMMUNITY_REPOSITORY will be added in the RepositoryConfig to indicate whether the given repository is a community repository or not.
5. In the CM Security code, if the IS_COMMUNITY_REPOSITORY flag is set for the given repository, it will ASSUME that the node has implicit properties called “nodeOwner” and “nodeVisitor” and will try to retrieve these properties.
6. Once retrieved, these properties will then be placed in the request and the isAccessAllowed call will be called on the node. This will then in turn cause the role to be evaluated to true or false based on the expression.
   Runtime Access

For embodiments using Delegated Administration (DA) as a security mechanism for content management, both for Administration as well as Runtime Access, content management processes will include modifications to enable functional elements, such as without limitation: cm tags, content selectors, placeholders and search, since in most cases the user would not be found to be in the correct role (as he is probably going to be in a visitor role). In an embodiment, all CM visitors/users are cast into DA roles. While there does seem to be overlap in the capabilities offered to CM DA users and visitors, clearly not all visitors are administrators.

In order for an administrator to gain access to content to a visitor in a conventional approach, the administrator will have to be made the visitor part of the PSA (Portal System Administrator) group by putting him in a DA Role. So, unknowingly the content administrator has given access to the AdminTools to a visitor. Accordingly, in order to create DA roles to represent CM visitors, such side affects of having all CM/DA role predicates (users/groups) added to the PSA role are avoided. In embodiments, this can be achieved by adding a checkbox to DA Role creation/update that indicates not to add the predicates to the PSA role.

Since in many popular applications, the majority of work in a CM system is read access, Create/Updates are relatively rare, and even if they occur it is safe to presume that customers will not experience problems putting those users in a DA role. Accordingly, the scope of the problem is decreased to providing a mechanism for visitors to have View access to a Content Resource. In an embodiment, this is performed as follows:
1. Create an out of the box DA Role (ContentAccessDARole) which is going to be based on the following rule: ContentAccessDARole=Anonymous Users+Normal Users (This also could be described as “all users”—both anonymous and authenticated).
2. Ensure that all users in WeblogicPortal will belong to this role.
3. Now the Content Administrator can set View capability at the repository on which he/she wants to provide read access and create a security policy with that particular resource.
4. Once he/she has done that, all content selectors/tags/placeholders will work fine, since they only need view access to the repository.
5. This solution may be extended—if the administrator is comfortable their end users updating content, he can simply add Update capability to that security policy for the role.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for interacting with a virtual content repository and providing content management security to federated content repositories as discussed herein.

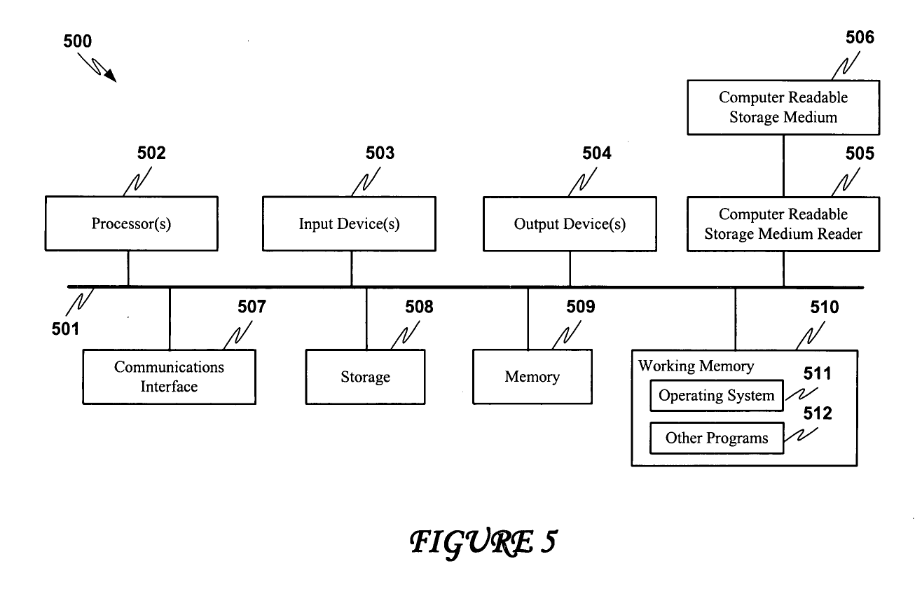

FIG. 5 illustrates a processing system 500, which can comprise one or more of the elements supporting the architecture of FIG. 1. Turning now to FIG. 5, a computing system is illustrated that may comprise one or more of the components supporting the architecture of FIG. 1. While other alternatives might be utilized, it will be presumed for clarity sake that components of the systems supporting the architecture of FIG. 1 are implemented in hardware, software or some combination by one or more computing systems consistent therewith, unless otherwise indicated.

Computing system 500 comprises components coupled via one or more communication channels (e.g., bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application. (It will be appreciated that input or output devices can also similarly include more specialized devices or hardware/software device enhancements suitable for use by the mentally or physically challenged.)

System 500 also includes a machine readable storage media reader 505 coupled to a machine readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 507 may also be included, such as a modem, DSL, infrared, RF or other suitable transceiver, and so on for providing inter-device communication directly or via one or more suitable private or public networks or other components that may include but are not limited to those already discussed.

Working memory 510 further includes operating system (“OS”) 511 elements and other programs 512, such as one or more of application programs, mobile code, data, and so on for implementing system 500 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 512 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for providing content management security to federated content repositories in a content management system, the method comprising:
integrating a plurality of content repositories, including a first content repository having a first security mechanism and a second content repository lacking any security mechanism, into a virtual content repository (VCR);
intercepting a request to access content stored in a first node of a plurality of nodes within the plurality of content repositories and a second node of the plurality of nodes within the plurality of content repositories, wherein the first node includes content stored in the first content repository and the second node includes content stored in the second content repository;
determining whether the request will be permitted by applying a security policy to a result set returned by the first content repository and the second content repository responsive to the request and applying the first security mechanism to only that portion of the result set returned by the first content repository; and
providing the result set when the request satisfies the security policy and the first security mechanism.

2. The method of claim 1, wherein intercepting a request to access content stored in a first node of a plurality of nodes within the plurality of content repositories and a second node of the plurality of nodes within the plurality of content repositories, wherein the first node includes content stored in the first content repository and the second node includes content stored in the second content repository includes:
intercepting the request at a common Application Programming Interface (API) providing access to the VCR.

3. The method of claim 1, wherein determining whether the request will be permitted by applying a security policy to a result set returned by the first content repository and the second content repository responsive to the request and applying the first security mechanism to only that portion of the result set returned by the first content repository includes:
determining based upon the result set that at least a portion of the result set is retrieved from the first content repository; and
applying the first security mechanism to only that portion of the result set returned by the first content repository.

4. The method of claim 1, wherein determining whether the request will be permitted by applying a security policy to a result set returned by the first content repository and the second content repository responsive to the request and applying the first security mechanism to only that portion of the result set returned by the first content repository includes:
determining based upon the result set that at least a portion of the result set is retrieved from the second content repository; and
applying only the security policy to only that portion of the result set returned by the second content repository.

5. The method of claim 1, wherein providing the result set when the request satisfies the selected security policy includes:
enabling at least one of navigation, CRUD operations (create, read, update, delete), versioning, workflows, and searching operations to operate on the plurality of repositories as though the plurality of repositories were one repository.

6. The method of claim 1, further comprising:
redacting content from the result set to make the result set permissible according to the selected security policy.

7. The method of claim 1, further comprising:
redacting content from only that portion of the result set returned by the second content repository to make the result set permissible according to the first security mechanism.

8. The method of claim 1, further comprising:
blocking access to an entity that at least partially satisfies the request when the request does not satisfy the selected security policy.

9. A machine-readable medium carrying one or more sequences of instructions for providing content management security to federated content repositories in a content management system, which instructions, when executed by one or more processors, cause the one or more processors to carry out the steps of:
integrating a plurality of content repositories, including a first content repository having a first security mechanism and a second content repository lacking any security mechanism, into a virtual content repository (VCR);
intercepting a request to access content stored in a first node of a plurality of nodes within the plurality of content repositories and a second node of the plurality of nodes within the plurality of content repositories, wherein the first node includes content stored in the first content repository and the second node includes content stored in the second content repository;
determining whether the request will be permitted by applying a security policy to a result set returned by the first content repository and the second content repository responsive to the request and applying the first security mechanism to only that portion of the result set returned by the first content repository; and
providing the result set when the request satisfies the security policy and the first security mechanism.

10. The machine-readable medium as recited in claim 9, wherein the instructions for carrying out the step of intercepting a request to access content stored in a first node of a plurality of nodes within the plurality of content repositories and a second node of the plurality of nodes within the plurality of content repositories, wherein the first node includes content stored in the first content repository and the second node includes content stored in the second content repository include instructions for carrying out the step of:
intercepting the request at a common Application Programming Interface (API) providing access to the VCR.

11. The machine-readable medium as recited in claim 9, wherein the instructions for carrying out the step of determining whether the request will be permitted by applying a security policy to a result set returned by the first content repository and the second content repository responsive to the request and applying the first security mechanism to only that portion of the result set returned by the first content repository include instructions for carrying out the step of:
determining based upon the result set that at least a portion of the result set is retrieved from the first content repository; and
applying the first security mechanism to only that portion of the result set returned by the first content repository.

12. The machine-readable medium as recited in claim 9, wherein the instructions for carrying out the step of determining whether the request will be permitted by applying a security policy to a result set returned by the first content repository and the second content repository responsive to the request and applying the first security mechanism to only that portion of the result set returned by the first content repository include instructions for carrying out the step of:
determining based upon the result set that at least a portion of the result set is retrieved from the second content repository; and
applying only the security policy to only that portion of the result set returned by the second content repository.

13. The machine-readable medium as recited in claim 9, wherein the instructions for carrying out the step of providing the result set when the request satisfies the selected security policy include instructions for carrying out the step of:
enabling at least one of navigation, CRUD operations (create, read, update, delete), versioning, workflows, and searching operations to operate on the plurality of repositories as though the plurality of repositories were one repository.

14. The machine-readable medium as recited in claim 9, further comprising instructions for carrying out the step of:
redacting content from the result set to make the result set permissible according to the selected security policy.

15. The machine-readable medium as recited in claim 9, further comprising instructions for carrying out the step of:
redacting content from only that portion of the result set returned by the second content repository to make the result set permissible according to the first security mechanism.

16. The machine-readable medium as recited in claim 9, further comprising instructions for carrying out the step of:
blocking access to an entity that at least partially satisfies the request when the request does not satisfy the selected security policy.

17. An apparatus for providing content management security to federated content repositories in a content management system, the apparatus comprising:
a processor; and
one or more stored sequences of instructions which, when executed by the processor, cause the processor to carry out the steps of:
integrating a plurality of content repositories, including a first content repository having a first security mechanism and a second content repository lacking any security mechanism, into a virtual content repository (VCR);
intercepting a request to access content stored in a first node of a plurality of nodes within the plurality of content repositories and a second node of the plurality of nodes within the plurality of content repositories, wherein the first node includes content stored in the first content repository and the second node includes content stored in the second content repository;
determining whether the request will be permitted by applying a security policy to a result set returned by the first content repository and the second content repository responsive to the request and applying the first security mechanism to only that portion of the result set returned by the first content repository; and
providing the result set when the request satisfies the security policy and the first security mechanism.

18. A method for transmitting code on a transmission medium, comprising:
transmitting code to integrate a plurality of content repositories, including a first content repository having a first security mechanism and a second content repository lacking any security mechanism, into a virtual content repository (VCR);
transmitting code to intercept a request to access content stored in a first node of a plurality of nodes within the plurality of content repositories and a second node of the plurality of nodes within the plurality of content repositories, wherein the first node includes content stored in the first content repository and the second node includes content stored in the second content repository;
transmitting code to determine whether the request will be permitted by applying a security policy to a result set returned by the first content repository and the second content repository responsive to the request and applying the first security mechanism to only that portion of the result set returned by the first content repository; and
transmitting code to provide the result set when the request satisfies the security policy and the first security mechanism.
